(19) United States
(12) Patent Application Publication
(10) Pub. No.: US 2012/0130519 A1
(43) Pub. Date: May 24, 2012

(54) SYSTEM AND METHOD FOR COMMUNICATING ZIGBEE-BASED AUDIO DATA

(75) Inventors: Eun Chang CHOI, Daejeon (KR); Jong Uk Lee, Gyeongsangbuk-do (KR); Jae Doo Huh, Daejeon (KR)

(73) Assignee: ELECTRONICS AND TELECOMMUNICATIONS RESEARCH INSTITUTE, Daejeon (KR)

(21) Appl. No.: 13/298,780

(22) Filed: Nov. 17, 2011

(30) Foreign Application Priority Data
Nov. 23, 2010 (KR) 10-2010-0116971

(51) Int. Cl. G06F 17/00

(52) U.S. Cl. 700/94

(57) ABSTRACT

An apparatus for transmitting Zigbee-based audio data includes a first communication unit to communicate an audio data generation apparatus; a second communication unit to communicate an audio data reception apparatus; a first buffer group comprising a plurality of buffers to store audio data; and a control unit to, when receiving an audio input command through the first communication unit, control the second communication unit to transmit a data transmission notification signal to the audio data reception apparatus, store audio data received through the first communication unit sequentially in the plurality of buffers, packetize the audio data stored in at least one buffer of the plurality of buffers, and control the second communication unit to transmit the packetized audio data to the audio data reception apparatus.

### CROSS-REFERENCE TO RELATED APPLICATION

This application claims the benefit of Korean Patent Application No. 10-2010-0116971, filed on Nov. 23, 2010, in the Korean Intellectual Property Office, the disclosure of which is incorporated herein by reference.

### BACKGROUND

1. Field of the Invention

Embodiments of the present invention relate to a system and method for communicating Zigbee-based audio data.

2. Description of the Related Art

Zigbee is a representative technology of a near field wireless sensor network achieving low power consumption, low cost, and ease of usability. Specifically, Zigbee standardizes a higher level protocol and application based on a physical layer (PHY) and a media access control (MAC) layer of IEEE 802.15.4 standard.

Based on the IEEE 802.15.4 standard, Zigbee uses the industrial, scientific and medical (ISM) frequency band, for example Europe −868 MHz, Americas −915 MHz, common −2.4 GHz, and has a maximum transmission rate of 250 kbps.

Zigbee is generally used in transmitting sensor data for home automation, that is, for controlling home appliances, lighting, and the like, or for smart energy providing power management in a home network.

A high capacity bandwidth is necessitated for communication of audio data. However, having such a narrow bandwidth makes it difficult for Zigbee to communicate relatively large data such as audio data.

### SUMMARY

An aspect of the present invention provides a system and method capable of communicating audio data with a low power consumption and a low cost using a Zigbee wireless network.

Another aspect of the present invention provides a system and method capable of generating and outputting audio data without relying on a codec, by sampling the audio data using a sampling timer.

Still another aspect of the present invention provides a system and method capable of efficiently utilizing a frequency bandwidth of a Zigbee wireless network, by communicating audio data only, while the audio data is being generated according to an audio input command.

According to an aspect of the present invention, there is provided an apparatus for transmitting Zigbee-based audio data, including a first communication unit to communicate an audio data generation apparatus, a second communication unit to communicate an audio data reception apparatus, a first buffer group comprising a plurality of buffers to store audio data, and a control unit to, when receiving an audio input command through the first communication unit, control the second communication unit to transmit a data transmission notification signal to the audio data reception apparatus, store audio data received through the first communication unit sequentially in the plurality of buffers, packetize the audio data stored in at least one of the plurality of buffers, and control the second communication unit to transmit the packetized audio data to the audio data reception apparatus.

According to another aspect of the present invention, there is provided an audio data reception apparatus including a first communication unit to communicate with an audio data transmission apparatus, a second communication unit to communicate with an audio data output apparatus, a buffer group comprising a plurality of buffers to store audio data, and a control unit to, when receiving a data transmission notification signal through the first communication unit, control the first communication unit to transmit a response signal corresponding to the data transmission notification signal to the audio data transmission apparatus, store the audio data through the first communication unit received through the first communication unit sequentially in the plurality of buffers, and control the second communication unit to transmit the audio data stored in at least one of the plurality of buffers to the audio data output apparatus.

According to still another aspect of the present invention, there is provided a system for communicating Zigbee-based audio data, the system including an audio data generation apparatus to generate audio data, an audio data transmission apparatus to, when receiving an audio input command, generate a data transmission notification signal, store audio data received from the audio data generation apparatus sequentially in a plurality of buffers included in a first buffer group, and packetize and transmit the audio data stored in at least one of the plurality of buffers of the first buffer group, an audio data reception apparatus to, when receiving the data transmission notification signal, transmit a response signal corresponding to the data transmission notification signal to the audio data transmission apparatus, receive the packetized audio data from the audio data transmission apparatus, and sequentially store the packetized audio data in a plurality of buffers included in a second buffer group, and an audio data output apparatus to receive, signal-process, and output the audio data stored in at least one of the plurality of buffers of the second buffer group.

According to yet another aspect of the present invention, there is provided an audio data communication method in a Zigbee-based audio data communication system, the method including storing audio data received from an audio data reception apparatus sequentially in a plurality of buffers included in a first buffer group, packetizing audio data stored in at least one of the plurality of buffers of the first buffer group, and transmitting the packetized audio data to an audio data reception apparatus, and receiving the packetized audio data from the audio data reception apparatus, storing the packetized audio data sequentially in a plurality of buffers included in a second buffer group, and outputting the audio data stored in the at least one of the plurality of buffers of the second buffer group through an audio data output apparatus.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a system for transmitting Zigbee-based audio data according to an embodiment of the present invention;

FIG. 2 is a diagram illustrating a system for receiving Zigbee-based audio data according to another embodiment of the present invention;

FIG. 3 is a flowchart illustrating a method for transmitting audio data according to still another embodiment of the present invention; and

FIG. 4 is a flowchart illustrating a method for receiving audio data according to yet another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

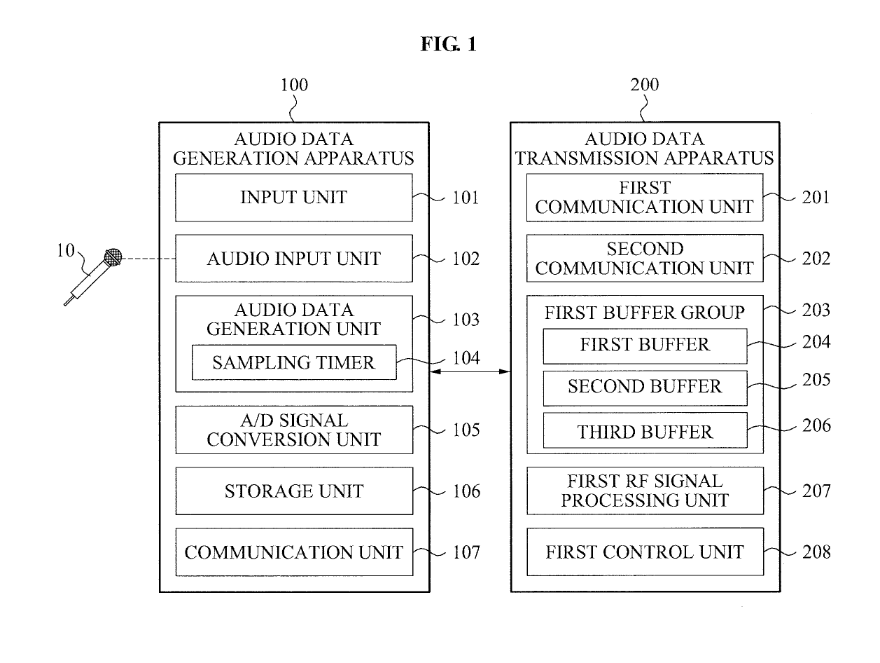

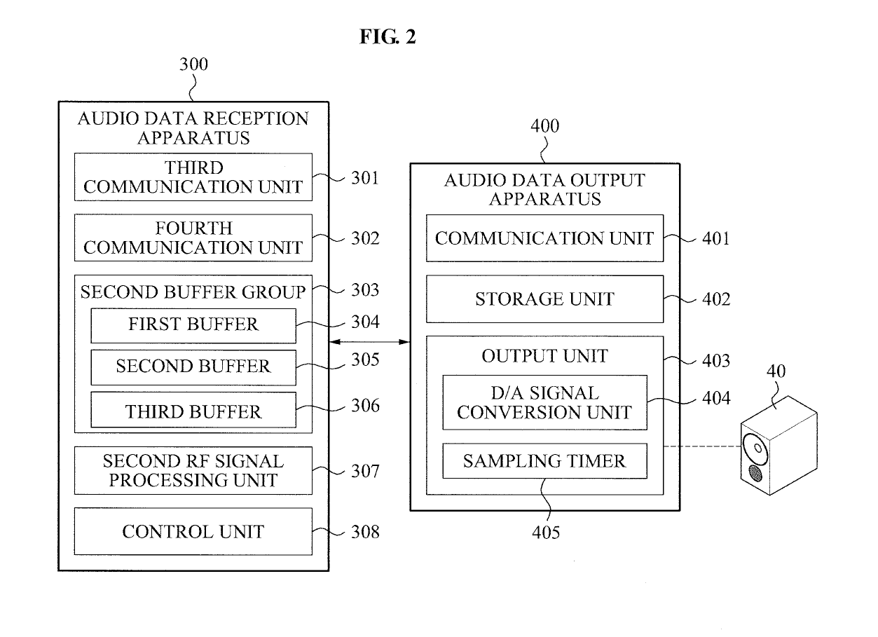

FIG. 1 is a diagram illustrating a system for transmitting Zigbee-based audio data according to an embodiment of the present invention. FIG. 2 is a diagram illustrating a system for receiving Zigbee-based audio data according to another embodiment of the present invention. The audio data transmission system shown in FIG. 1 may include an audio data generation apparatus 100 and an audio data transmission apparatus 200. The audio data reception system shown in FIG. 2 may include an audio data reception apparatus 300 and an audio data output apparatus 400.

The systems shown in FIGS. 1 and 2 may be integrated into one audio data communication system. The audio data communication system may perform generation of audio data, transmission and reception of the audio data, and output of the audio data among Zigbee-based apparatuses present in a Zigbee wireless network.

The audio data generation apparatus 100 may be an audio recording apparatus that generates audio data from audio input through a microphone 10. The audio data output apparatus 400 may output the audio data as a sound audible to the human ear through a speaker 40. In addition, the audio data transmission apparatus 200 and the audio data reception apparatus 300 may be one of a coordinator device, a router device, and a terminal device complying with the Zigbee network standard. Also, the audio data transmission apparatus 200 and the audio data reception apparatus 300 may establish wireless personal area networks (WPAN) between each other.

Hereinafter, operations of the apparatuses constituting an audio data communication system will be described in detail.

The audio data generation apparatus 100 may include an input unit 101, an audio input unit 102, an audio data generation unit 103, an analog/digital (A/D) signal conversion unit 105, a storage unit 106, and a communication unit 107.

The input unit 101 may refer to a user input device such as an input key or touch panel equipped to a main body of the apparatus. For example, when a user pushes the audio input key as the input unit 101, the input unit 101 generates an audio input command. The communication unit 107 may transmit the generated audio input command to the audio data transmission apparatus 200.

The input unit 101 may generate an audio input stop command in addition to the audio input command. The audio input stop command may be generated when the user pushes a key for stopping or ending audio input.

When the audio input command is generated, the audio input unit 102 may operate in an audio input mode for inputting audio through the microphone 10. The audio input unit 102 may generate audio data from the audio being input through the microphone 10.

The audio input unit 102 includes a sampling timer 104 to sample the audio being input, according to a predetermined sampling period. When sampling the audio data, the sampling timer 104 may determine the sampling period every time the audio is input. The sampling period may be a sampling period applied to previously input audio, or any one randomly selected from a plurality of sampling periods.

While the sampling timer 104 is sampling the audio during the predetermined sampling period, when an interrupt in accordance with the sampling period occurs the audio input unit 102 may generate the audio data from the audio input through the microphone 10.

However, when an interrupt not in accordance with the sampling period occurs the audio input unit 103 may not perform the sampling. In this state, when an interrupt occurs according to a next sampling period, the audio input unit 102 may initialize a coefficient of the sampling timer 104 and then generate the audio data.

The A/D signal conversion unit 105 may convert the audio data in the form of an analog signal into a digital signal.

The storage unit 106 may temporarily store the audio data in the form of the digital signal before the audio data is transmitted to the audio data transmission apparatus 200. The storage unit 106 may be a register included in a central processing unit (CPU) of the audio data generation apparatus 100.

The communication unit 107 may communicate with the audio data transmission apparatus 200 using a wired or wireless connection. That is, the communication unit 107 may transmit the audio input command and the audio input stop command generated by the input unit 101 to the audio data transmission apparatus 200. Also, the communication unit 107 may transmit the audio data temporarily stored in the storage unit 106 to the data transmission apparatus 200.

The audio data transmission apparatus 200 may include a first communication unit 201, a second communication 202, a first buffer group 203, a first radio frequency (RF) signal processing unit 207, and a first control unit 208.

The first communication unit 201 communicates with the audio data generation apparatus 100.

The second communication unit 202 communicates with the audio data transmission apparatus 200.

The first buffer group 203 may include a plurality of buffers, that is, a first buffer 204, a second buffer 205, and a third buffer 206 for storing the audio data. However, the first buffer group 203 may include more buffers. The first buffer 204, the second buffer 205, and the third buffer 206 may have capacities to store packets in a range of data size communicable in the Zigbee wireless network. Furthermore, the capacities may be configured to store a packet having a maximum data size in the data size range.

The first RF signal processing unit 207 may perform RF signal processing with respect to the audio data.

The first control unit 208 may control the operation of the audio data transmission apparatus 200, especially the operation related to communication of the audio data.

The first control unit 208 may operate in the audio input mode when receiving the audio input command through the first communication unit 201.

When communicating other data, not the audio data, through the Zigbee wireless network, the audio data transmission apparatus 200 may operate in an audio input standby mode in which a standby power or a minimum power is supplied to structures related to the audio data communication. When the audio input command is received during the operation in the audio input standby mode, the first control unit 208 may supply a normal power to the structures related to the audio data communication so that the audio data transmission apparatus 200 operates in the audio input mode.

When the operation starts in the audio input mode, the first control unit 208 may control the second communication unit 202 to transmit network address information of the audio data transmission apparatus 200 to the audio data reception apparatus 300, and may receive network address information of the audio data reception apparatus 300 through the second communication unit 202, so as to set the Zigbee wireless network. In this case, the network address information may use a Zigbee-based address expression method.

When receiving the audio input command through the first communication unit 201, the first control unit 208 may control the second communication unit 202 to transmit the audio input command to the audio data reception apparatus 300 by generating a data transmission notification signal. During this receiving, the first control unit 208 may determine attribute information related to the audio data, corresponding to the audio input command. In addition, the first control unit 208 may transmit the attribute information contained in the data transmission notification signal to the audio data reception apparatus 300.

The attribute information may contain at least one selected from a sampling period for the audio data to be received from the audio data generation apparatus 100, codec information, security provision information, and stereo support information. The second communication unit 202 may receive a response signal corresponding to the data transmission notification signal from the audio data reception apparatus 300.

When the audio data is received through the first communication unit 201, the first control unit 208 may store the audio data in the first buffer 204, the second buffer 205, and the third buffer 206, sequentially. That is, the first control unit 208 may store the audio data from a foremost storage area of the first buffer 204.

When the size of the audio data exceeds a capacity of the first buffer 204, that is, when the audio data occupies the whole storage space of the first buffer 204, the first control unit 208 may successively store a remaining part of the audio data in the second buffer 205, which is the next buffer of the first buffer 204.

In the same manner, when the size of the audio data exceeds a capacity of the second buffer 205, the first control unit 208 may successively store a remaining part of the audio data in the third buffer 206, which is the next buffer of the second buffer 205.

The first control unit 208 may packetize the audio data stored in at least one of the first buffer 204, the second buffer 205, and the third buffer 206. Next, the first control unit 208 may control the second communication unit 202 to transmit the packetized audio data to the audio data reception apparatus 300. As aforementioned, when the size of the audio data exceeds the capacity of the first buffer 204, the audio data stored in the first buffer 204 may be packetized and then transmitted to the audio data reception apparatus 300. During this packetizing and transmitting, RF signal processing is performed with respect to the packetized audio data through the first RF signal processing unit 207.

In addition, when the audio data stored in the first buffer 204 is transmitted to the audio data reception apparatus 300, the first control unit 208 may control the first buffer group 203 to initialize the first buffer 204. Such an operation may also be applied to the second buffer 205 and the third buffer 206 in the same manner.

When receiving the audio input stop command through the first communication unit 201, the first control unit 208 may control the second communication unit 202 to transmit a data transmission stop signal to the audio data reception apparatus 300. The first control unit 208 may supply the standby power or the minimum power to the structures related to the audio data communication so that the audio data transmission apparatus 200 operates in the audio input standby mode.

In FIG. 1, transmission of the audio data from the audio data transmission apparatus 200 to the audio data reception apparatus 300 in accordance with the Zigbee network standard may be performed by one-hop or multi-hop. Also, the audio data transmission apparatus 200 may transmit the audio data to at least one audio data reception apparatus by any of unicast, multicast, and broadcast.

The audio data reception apparatus 300 may include a third communication unit 301, a fourth communication unit 302, a second buffer group 303, a second RF signal processing unit 307, and a second control unit 308.

The third communication unit 301 communicates with the audio data transmission apparatus 200.

The fourth communication unit 302 communicates with the audio data output apparatus 400.

The second buffer group 303 may include a plurality of buffers, for example, a first buffer 304, a second buffer 305, and a third buffer 306 for storing the audio data. The second buffer group 303 may include more buffers.

The second RF signal processing unit 307 may perform RF signal processing with respect to a signal or data to be transmitted to the audio data transmission apparatus 200.

The second control unit 308 may control the operation of the audio data reception apparatus 300, especially the operation related to communication of the audio data.

When receiving the data transmission notification signal through the third communication unit 301, the second control unit 308 may generate the response signal corresponding to the data transmission notification signal. More specifically, the second control unit 308 may check attribute information related to the audio data contained in the data transmission notification signal, thereby determining whether output of the audio data through the audio data output apparatus 400 is available.

The second control unit 308 may determine availability of output of the audio data by comparing the attribute information with output specification information of the audio data output apparatus 400.

The audio data reception apparatus 300 may include the output specification information regarding the audio data output apparatus 400. Alternatively, when receiving the data transmission notification signal, the audio data reception apparatus 300 may be provided with the output specification information by the audio data output apparatus 400 by request.

When output of the audio data is determined to be available, the second control unit 308 may control the third communication unit 301 to transmit the response signal corresponding to the data transmission notification signal to the audio data transmission to apparatus 200.

When receiving the audio data through the third communication unit 301, the second control unit 308 may store the audio data sequentially in the first buffer 304, the second buffer 305, and the third buffer 306. More specifically, the second control unit 308 may store the audio data from a foremost storage area of the first buffer 304.

When the size of the audio data exceeds a capacity of the first buffer 304, the second control unit 308 may successively store a remaining part of the audio data in the second buffer 305, which is the next buffer of the first buffer 304.

In the same manner, when the size of the audio data exceeds a capacity of the second buffer 305, the second control unit 308 may successively store a remaining part of the audio data in the third buffer 306, which is the next buffer of the second buffer 305.

The second communication unit 308 may control the second communication unit 202 to transmit the audio data stored in at least one of the first buffer 304, the second buffer 305, and the third buffer 306, to the audio data output apparatus 400. That is, when the size of the audio data exceeds the capacity of the first buffer 304, the audio data stored in the first buffer 304 may be transmitted to the audio data output apparatus 400.

When the audio data stored in the first buffer 304 is transmitted to the audio data reception apparatus 300, the second control unit 308 may control the first buffer group 203 to initialize the first buffer 304. Such an operation may be also applied to the second buffer 305 and the third buffer 306 in the same manner.

When receiving the data transmission stop signal through the first communication unit 201, the second control unit 308 may supply the standby power or the minimum power to the structures related to the audio data communication so that the audio data reception apparatus 300 operates in the audio input standby mode.

The audio data reception apparatus 300 shown in FIG. 2 may transmit a transmission stop request regarding the audio data to the audio data transmission apparatus 200. In addition, the audio data transmission apparatus 200 may function as a reception apparatus. Also, the audio data reception apparatus 300 may function as a transmission apparatus.

The audio data transmission apparatus 200 and the audio data reception apparatus 300 may perform real-time two-way communication in a half-duplex manner. Also, the audio data transmission apparatus 200 and the audio data reception apparatus 300 may reinforce data security during communication of the audio data, using a security system provided by the Zigbee network standard.

The audio data output apparatus 400 may include a communication unit 401, a storage unit 402, and an output unit 403.

The communication unit 401 may receive the audio data by communicating with the audio data reception apparatus 300.

The storage unit 402 may temporarily store the audio data received through the communication unit 401 before the audio data is output.

The output unit 403 may include a D/A signal conversion unit 404 and a sampling timer 405.

The output unit 403 may arrange a plurality of the audio data received through the communication unit 410 in order, by checking sequence numbers recorded in headers of the plurality of audio data. When the audio data is damaged, the output unit 403 may sample previous audio data of the damaged audio data, among the plurality of audio data received in units of packets, during a sampling period. The sampling timer 405 may sample the audio data by the same sampling period as the sampling period used when the audio data is generated from the audio data generation apparatus 100.

The D/A signal conversion unit 404 may convert the sampled audio data in the form of the digital signal into an analog signal, and output the analog signal. Although not shown, the audio data in the form of the analog signal may be amplified through an amplifier (not shown) when output.

A speaker 40 may output the audio data output through the output unit 403 as a sound audible to the human ear.

Referring to FIGS. 1 and 2, the audio data communication system communicates the audio data through the Zigbee wireless network. Accordingly, the audio data communication may be achieved with a low power consumption and low cost.

Furthermore, when the audio data communication system generates and outputs the audio data, audio data is sampled by the sampling timer. That is, generation and output of the audio data may be performed without a codec.

In addition, the audio data communication system performs the audio data communication only while the audio data is being generated according to the audio input command. Therefore, a frequency bandwidth of the Zigbee wireless network may be utilized efficiently.

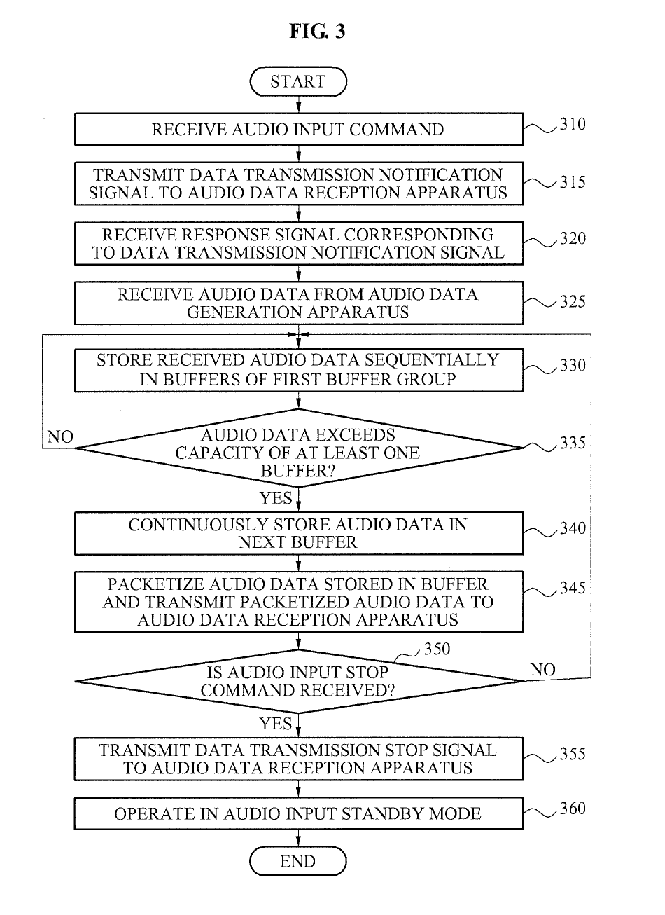

FIG. 3 is a flowchart illustrating a method for transmitting audio data according to an embodiment of the present invention. The method illustrated in FIG. 3 is performed by the audio data transmission apparatus 200 illustrated in FIG. 1. That is, the method of FIG. 3 includes the signal and data communication process between the audio data generation apparatus 100 and the audio data reception apparatus 300.

Referring to FIG. 3, when the audio data transmission apparatus 200 receives the audio input command from the audio data generation apparatus 100 in operation 310, the audio data transmission apparatus 200 transmits the data transmission notification signal to the audio data reception apparatus 300 in operation 315. Here, the Zigbee wireless network may be set between the audio data transmission apparatus 200 and the audio data reception apparatus 300.

The audio data transmission apparatus 200 may receive the response signal corresponding to the data transmission notification signal from the audio data reception apparatus 300 in operation 320. The audio data transmission apparatus 200 may perform the audio data communication with the audio data reception apparatus 300 using the response signal.

When the audio data transmission apparatus 200 receives the audio data from the audio data generation apparatus 100 in operation 325, the received audio data may be sequentially stored in the plurality of buffers included in the first buffer group 203, in operation 330. For example, when the first buffer group 203 includes the first buffer 204, the second buffer 205, and the third buffer 206, the audio data transmission apparatus 200 may store the audio data from a foremost storage area of the first buffer 204.

When the size of the audio data exceeds a capacity of at least one of the plurality of buffers in operation 335, the audio data transmission apparatus 200 may successively store the audio data in a next buffer in operation 340. For example, when the size of the audio data exceeds a capacity of the first buffer 204, a remaining part of the audio data may be successively stored in the second buffer 205 and the third buffer 206, which are buffers subsequent to the first buffer 204.

In operation 345, the audio data transmission apparatus 200 may packetize the audio data stored in at least one of the plurality of buffers, and transmit the packetized audio data to the transmit reception apparatus 300. For example, when the size of the audio data exceeds the capacity of the first buffer 240, the audio data stored in the first buffer 204 is packetized and transmitted to the audio data reception apparatus 300. During this packetizing and transmitting, RF signal processing may be performed with respect to the packetized audio data. In addition, when the packetized audio data is transmitted to the audio data transmission apparatus 300, the first buffer 204 may be initialized.

The audio data transmission apparatus 200 may packetize the audio data in accordance with the Zigbee network standard. The audio data transmission apparatus 200 may be implemented as a sensor network apparatus by distinguishing the audio data from other data using an application support layer (ASP) capable of distinguishing information recorded in a header of a packet.

When the audio data transmission apparatus 200 receives the audio input stop command from the audio data generation apparatus 100 in operation 350, the audio data transmission apparatus 200 transmits the data transmission stop signal to the audio data reception apparatus 300 in operation 355.

In operation 360, the audio data transmission apparatus 200 supplies the standby power or the minimum power to the structures related to the audio data communication, to accordingly operate in the audio input standby mode.

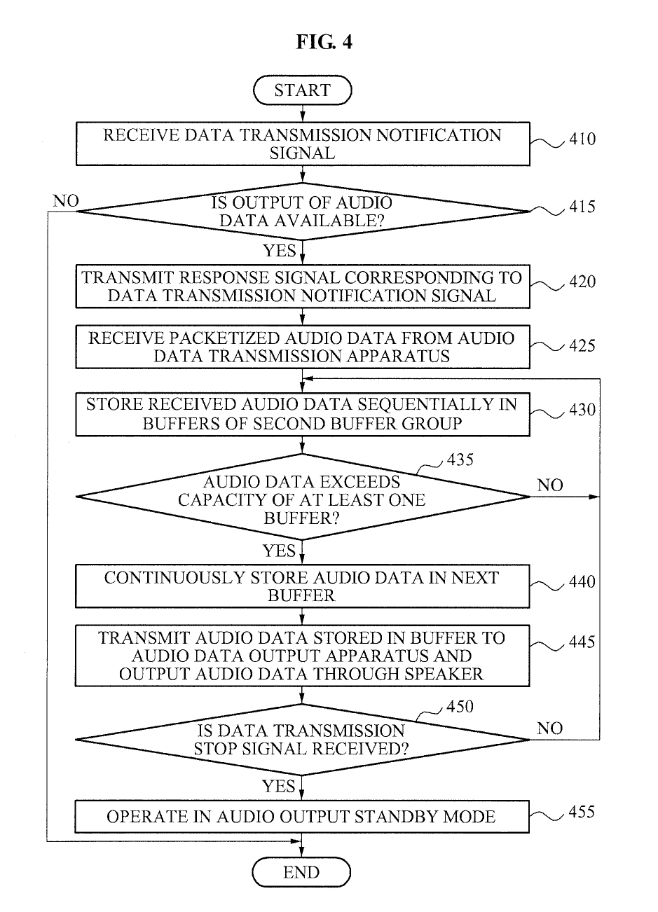

FIG. 4 is a flowchart illustrating a method for receiving audio data according to an embodiment of the present invention. The method illustrated in FIG. 4 is performed by the audio data reception apparatus 300 illustrated in FIG. 2. That is, the method of FIG. 4 includes the signal and data communication process between the audio data transmission apparatus 200 and the audio data output apparatus 400.

Referring to FIG. 4, when the audio data reception apparatus 300 receives the data transmission notification signal from the audio data transmission apparatus 200 in operation 410, it is determined whether output of the audio data is available in operation 415. The audio data transmission apparatus 200 may determine availability of output of the audio data by comparing the attribute information of the audio data with the output specification information of the audio data output apparatus 400.

When it is determined that output of the audio data is available, the audio data reception apparatus 300 may transmit the response signal corresponding to the data transmission notification signal to the audio data transmission apparatus 200 in operation 420.

When the audio data reception apparatus 300 receives the packetized audio data from the audio data transmission apparatus 200 in operation 425, the audio data reception apparatus 300 may store the received audio data sequentially in the plurality of buffers of the second buffer group 303 in operation 430. For example, when the second buffer group 303 includes the first buffer 304, the second buffer 305, and the third buffer 306, the audio data transmission apparatus 200 may store the audio data from the foremost storage area of the first buffer 304.

When the size of the audio data exceeds capacity of at least one of the plurality of buffers in operation 435, the audio data reception apparatus 300 may successively store the audio data in a next buffer in operation 440. For example, when the size of the audio data exceeds capacity of the first buffer 304, a remaining part of the audio data may be successively stored in the second buffer 305 and the third buffer 306, which are the next buffers of the first buffer 304.

In operation 445, the audio data reception apparatus 300 may transmit the audio data stored in at least one of the plurality of buffers to the audio data output apparatus 400, so that the audio data is output through the speaker 40.

The audio data output apparatus 400 may convert the audio data in the form of the analog signal, received from the audio data reception apparatus 300, into the digital signal. Additionally, the audio data output apparatus 400 may sample the audio data in the form of the digital signal by the sampling period using the sampling timer, and output the sampled audio data through the speaker 40,

When the audio data reception apparatus 300 receives the data transmission stop signal from the audio data transmission apparatus 200 in operation 450, the audio data reception apparatus 300 supplies the standby power or the minimum power to the structures related to the audio data communication to operate in the audio input standby mode in operation 455.

As described with reference to FIGS. 3 and 4, the audio data communication system may communicate audio data through the Zigbee wireless network, and generate and output the audio data without relying on a codec. In addition, the audio data communication system performs audio data communication only during generation of the audio data, thereby efficiently utilizing the frequency bandwidth of the Zigbee wireless network.

The system and method for communicating through the Zigbee-based audio data may achieve the audio data communication with a low power consumption and low cost through the Zigbee wireless network.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for transmitting Zigbee-based audio data, comprising:
a first communication unit to communicate an audio data generation apparatus;
a second communication unit to communicate an audio data reception apparatus;
a first buffer group comprising a plurality of buffers to store audio data; and
a control unit to, when receiving an audio input command through the first communication unit, control the second communication unit to transmit a data transmission notification signal to the audio data reception apparatus, store audio data received through the first communication unit sequentially in the plurality of buffers, packetize the audio data stored in at least one of the plurality of buffers, and control the second communication unit to transmit the packetized audio data to the audio data reception apparatus.

2. The apparatus of claim 1, wherein, when size of the audio data exceeds a capacity of at least one of the plurality of buffers, the control unit successively stores the audio data in a next buffer of the at least one buffer.

3. The apparatus of claim 1, wherein, when the control unit packetizes the audio data stored in the at least one buffer and then transmits the packetized audio data to the audio data reception apparatus, the control unit controls the first buffer group to initialize the at least one buffer.

4. The apparatus of claim 1, wherein, when receiving an audio input stop command through the first communication unit, the control unit controls the second communication to transmit a data transmission stop signal to the audio data reception apparatus and operates in an audio input standby mode by supplying standby power to the first communication unit, the second communication unit, and the first buffer group.

5. The apparatus of claim 1, wherein the control unit determines attribute information regarding the audio data corresponding to the audio input command, and transmits the attribute information contained in the data transmission notification signal to the audio data reception apparatus.

6. The apparatus of claim 5, wherein the attribute information comprises at least one selected from a sampling period for audio data to be received from the audio data generation apparatus, resolution information, codec information, security provision information, and stereo support information.

7. The apparatus of claim 1, wherein the plurality of buffers have capacity capable of storing a packet in a range of data size communicable in a Zigbee wireless network.

8. An audio data reception apparatus comprising:
a first communication unit to communicate with an audio data transmission apparatus;
a second communication unit to communication with an audio data output apparatus;
a buffer group comprising a plurality of buffers to store audio data; and
a control unit to, when receiving a data transmission notification signal through the first communication unit, control the first communication unit to transmit a response signal corresponding to the data transmission notification signal to the audio data transmission apparatus, store the audio data through the first communication unit received through the first communication unit sequentially in the plurality of buffers, and control the second communication unit to transmit the audio data stored in at least one of the plurality of buffers to the audio data output apparatus.

9. The audio data reception apparatus of claim 8, wherein, when a size of the audio data exceeds a capacity of at least one of the plurality of buffers, the control unit successively stores the audio data to a next buffer of the at least one buffer.

10. The audio data reception apparatus of claim 8, wherein the control unit controls the buffer group to initialize the at least one buffer when transmitting the audio data stored in the at least one buffer to the audio data output apparatus.

11. The audio data reception apparatus of claim 8, wherein the control unit checks attribute information regarding the audio data contained in the data transmission notification signal and, when output of the attribute information through the audio data output apparatus is available, controls the first communication to transmit the response signal corresponding to the data transmission notification signal to the audio data transmission apparatus.

12. The audio data reception apparatus of claim 8, wherein, when receiving a data transmission stop signal through the first communication unit, the control unit operates in an audio output standby mode by supplying standby power to the first communication unit, the second communication unit, and the first buffer group.

13. A system for communicating Zigbee-based audio data, the system comprising:
an audio data generation apparatus to generate audio data;
an audio data transmission apparatus to, when receiving an audio input command, generate a data transmission notification signal, store audio data received from the audio data generation apparatus sequentially in a plurality of buffers included in a first buffer group, and packetize and transmit the audio data stored in at least one of the plurality of buffers of the first buffer group;
an audio data reception apparatus to, when receiving the data transmission notification signal, transmit a response signal corresponding to the data transmission notification signal to the audio data transmission apparatus, receive the packetized audio data from the audio data transmission apparatus, and sequentially store the packetized audio data in a plurality of buffers included in a second buffer group; and
an audio data output apparatus to receive, signal-process, and output the audio data stored in at least one of the plurality of buffers of the second buffer group.

14. The system of claim 13, wherein, when audio is input, the audio data generation apparatus samples the audio according to a sampling period using a sampling timer, thereby generating audio data in the form of an analog signal, converts the audio data into a digital signal, and transmits the digital signal to the audio data transmission apparatus.

15. The system of claim 13, wherein, when a size of the audio data exceeds a capacity of the at least one of the plurality of buffers of the first buffer group, the audio data transmission apparatus successively stores the audio data in a next buffer of the at least one buffer.

16. The system of claim 13, wherein the, when the size of the audio data exceeds the capacity of the at least one buffer of the plurality of buffers of the second buffer group, the audio data reception apparatus successively stores the audio data in a next buffer of the at least one buffer.

17. The system of claim 13, wherein the audio data output apparatus converts the audio data in the form of the digital signal into an analog signal, and samples the audio data by the same sampling period as a sampling period used when the audio data is generated using a sampling timer.

18. An audio data communication method in a Zigbee-based audio data communication system, the method comprising:
storing audio data received from an audio data reception apparatus sequentially in a plurality of buffers included in a first buffer group, packetizing audio data stored in at least one of the plurality of buffers of the first buffer group, and transmitting the packetized audio data to an audio data reception apparatus; and
receiving the packetized audio data from the audio data reception apparatus, storing the packetized audio data sequentially in a plurality of buffers included in a second buffer group, and outputting the audio data stored in the at least one of the plurality of buffers of the second buffer group through an audio data output apparatus.

19. A non-transitory computer readable recording medium storing a program to cause a computer to implement the method of claim 18.
